(19) United States
(12) Patent Application Publication
(10) Pub. No.: US 2005/0249147 A1
(43) Pub. Date: Nov. 10, 2005

(54) Wireless network telecommunications system

(75) Inventor: Brian Fowler, Sunrise, FL (US)

Correspondence Address: FRIED, FRANK, HARRIS, SHRIVER & JACOBSON, 1001 PENNSYLVANIA AVE., N.W., SUITE 800, WASHINGTON, DC, 20004-2505, US

(73) Assignee: theglobe.com, Fort Lauderdale, FL (US)

(21) Appl. No.: 10/838,793

(22) Filed: May 4, 2004

(51) Int. Cl. H04Q 7/00

(52) U.S. Cl. 370/328

(57) ABSTRACT

A private exchange telephone system implemented within a wireless router so as to enable wireless devices connected to the router to operate like standard telephones connected to a PBX. The router includes a softswitch that allows the router to operate as the equivalent of a PSTN central office, effectuating a gateway between a packet-switched network and wireless telephony devices, such as PDAs and other types of wireless devices, in communication with the router. The router utilizes flash memory to store and operate the kernel and root file system for the router, as well as a variety of telephony applications, such as voicemail to e-mail conversion, auto-attendant, conferencing, automatic call distribution and caller identification. The router also provides availability for administrative management, roaming extensions, and branch office support for toll bypass and remote employee integration.

### SUMMARY OF THE INVENTION

The present invention relates generally to the field of Internet telephony and more particularly to a private exchange telephone system implemented within a wireless router so as to enable wireless devices connected to the router to operate like standard telephones connected to a PBX. The router includes a softswitch that allows the router to operate as the equivalent of a PSTN central office, effectively a gateway between the Internet, a packet-switched network, and wireless telephony devices, such as PDAs and other types of wireless devices, in communication with the router. The present invention utilizes a journaling flash file system 2 (“JFFS2”) to operate the kernel and root file system for the router, as well as a variety of telephony applications, such as voicemail to e-mail conversion, auto-attendant, conferencing, automatic call distribution and caller identification. The present invention also provides availability for administrative management, roaming extensions, and branch office support for toll bypass and remote employee integration.

### BACKGROUND OF THE INVENTION

Internet-based telephone services, or IP telephony, offers significant benefits over traditional telephone services. Although users generally pay a fee for Internet access, it is usually a set amount on a monthly basis regardless of the amount of bandwidth used. If two people use the Internet to call one another, they can by-pass both local telephone company, cellular and long distance networks, without incurring additional fees for making such a call. Because of these added benefits, consumers are increasingly interested in Internet telephony services. IP telephony offers additional benefits to users of wireless communications systems that utilize Wi-Fi enabled hardware terminals and similar wireless devices, because such devices enable users to connect to the Internet from a number of locations while completely by-passing telephone and cellular company networks in the process. Because wireless enabled terminals use wireless specifications that ensure universal communication compatibility, such compatibility allows for the Internet telephony service providers to offer their subscribers worldwide connectivity and a great value for telephone communication.

Wireless packet switched networks are designed for data communication. In a wireless network, messages to and from wireless devices, such as personal computers, PDAs, or other wireless devices, are broken into data packets and sent to and from the devices via radio airwaves. The wireless component of the network is usually just a local area network (LAN) that provides access points for connecting the wireless devices to the LAN. The access points act as wireless transceivers. Each wireless device contains hardware that enables the device to establish a link between the device and an access point.

Many wireless LANs are implemented through wireless routers, such as the Linksys Model WRT54G Wireless-G Broadband Router by Cisco Systems, Inc. of San Jose, Calif., and the Netgear Model DB834F 54 Mbps Wireless ADSL Firewall Router by Netgear, Inc. of Santa Clara, Calif. Such routers typically include wireless access points compatible with the 802.11g standard, 10/100 LAN switches, and a router function. Such routers could also include cable and DSL modem capabilities and firewall resources. In home or small office environments, the modem connection is of particular importance because it provides for a high speed connection to the Internet. The router function enables the router to direct packets through interconnected networks to an intended recipient by selecting a path over which to send packets to the specified destination. The router selects the best path using Internet Protocol (IP) packet headers and routing tables.

The 802.11 standard was published by the Institute of Electrical and Electronic Engineers (IEEE) in order to standardize radio frequencies and transmission rates. The IEEE has published three different standards for 802.11. One of the first, and currently the most commonly used, standard is 802.11b or Wireless-B. Wireless-B was released in 1999 and it uses the 2.4 GHz radio band and has a maximum transmission rate of 11 Mbps. Wireless-B operates on three non-overlapping channels. The IEEE published a second standard in 1999, 802.11a or Wireless A. Wireless-A is less prevalent than Wireless-B. Wireless-A allows for a 54 Mbps transmission rate at 5 GHz with eight non-overlapping channels. 802.11g or Wireless-G is the most recent wireless networking standard published by the IEEE to address the shortcomings of the earlier standards. Wireless-G is almost five times faster than the Wireless-B products that are used in homes, businesses and public wireless areas around the country, providing data at a transmission rate of 54 MBps. Wireless G also operates on the lower frequency of the 2.4 GHz band which allows for a greater range for users than does the 5 GHz band used by 802.11a. However, because Wireless B and Wireless G share the same 2.4 GHz radio band, Wireless-G devices are interoperable with existing Wireless-B equipment.

Wireless-G enabled routers typically include firmware that can be modified by a user through a port. Such routers generally run a UNIX type operating system, consisting of three parts: the kernel, standard utility programs, and the system configuration files. The kernel is the main part of the operating system. It is a large program that is loaded into memory once a machine is turned on. The kernel controls the allocation of hardware resources. The standard utility programs include basic utility programs such as cp, which copies files and the shell which allows users to give commands to the system. Linux is a popular free version of a Unix-type operating system.

### BRIEF DESCRIPTION OF THE DRAWING

FIG. 1 is a diagram of the firmware environment of a wireless router modified to include private exchange features in accordance with the present invention.

### DETAILED DESCRIPTION OF THE INVENTION

The present invention can be implemented within any type of wireless router or access point device. In accordance with the best mode, the present invention is preferably implemented as a firmware update to an existing Wireless-G router as such routers currently provide sufficient hardware and software resources to implement the present invention.

The present invention enables a Wireless-G router to operate as a softswitch. A softswitch typically serves as a gateway between a circuit-switched PSTN and a packet-switched network, such as the Internet. The softswitch registers wireless devices and routes appropriate telephone extensions to them so as to enable such devices to operate as telephones. Many private business exchanges, or PBXs, implement a softswitch, thereby enabling callers to place calls over both the PSTN and the Internet. Softswitches have not been implemented within wireless access point devices, such as wireless routers.

In accordance with the present invention, the firmware update modifies the operation of the Wireless-G router so as to support a wide variety of telephony add-on applications, including the softswitch, by taking advantage of the Linux operating system being utilized by the router. The operating system, using the Linux 2.4.20 kernel, or higher, a root file system, and common UNIX utilities, provides a minimal Linux environment suitable for booting the router and providing basic functionality.

A particularly important aspect of the present invention is the utilization of JFFS2 to install the kernel and root file system, while utilizing the remaining portion of the flash to operate the read/write file system. JFFS2 is designed for use on flash devices in embedded systems, such as flash chips installed within the router. JFFS2 operates directly on the flash chips. By placing the file system directly on the flash, the inefficiency associated with having two journaling file systems on top of each other is avoided.

The softswitch functionality of the present invention is referred to herein as a registration daemon because it is an agent program that continuously operates in conjunction with the UNIX kernel of the router (which is effectively a UNIX server) and that provides resources to client systems on the router's network. As implemented in accordance with the present invention, the softswitch is preferably a thin client application, requiring approximately 20 KB of data space.

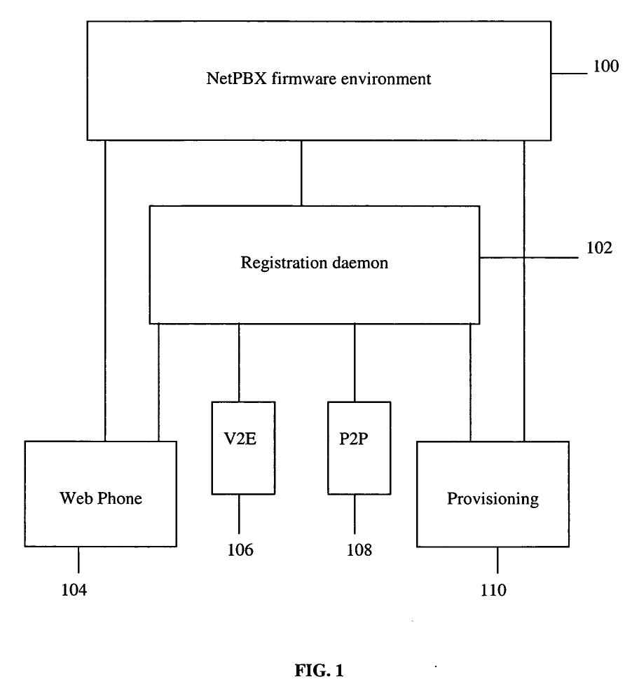

With reference to FIG. 1, in addition to the registration daemon 102 operating in process with the firmware environment 100, the telephony applications can include any of the following: a web phone application 104; a voicemail to e-mail daemon 106; a peering daemon 108; a provisioning daemon 110; as well as many other applications.

As noted above, the registration daemon 102 is the core of the telephony network established within the router. In addition to its registration function, one of its primary features is its transparent interoperation with a network address translation (NAT) firewall so as to enable the simultaneous users of the router to place, receive and transfer calls, even though the router only has a single dedicated IP address. The implementation of a softswitch function within a wireless router also enables the resulting PBX system to be totally portable. Once a softswitch-enabable Wi-Fi router is connected to the Internet, referred to herein as a “NetPBX,” anywhere in the world, a user with a Wi-Fi device, such as personal computer or PDA, within range of the NetPBX (and registered appropriately) can initiate a web telephone call—from anywhere in the world.

The web phone application 104 is also a thin client application, approximately 200 KB, and is hosted from the internal web engine of the router. Since the web phone application always runs from a web browser, it does not need to be manually downloaded for use. Once a browser session is initiated with the router's internal web engine, the web phone is automatically downloaded and installed. The web phone takes the voice transmission from the microphone on a multimedia PC and converts it into packet data for delivery to another connected web phone. In the same manner, the web phone receives incoming data packets representing voice transmissions and converts and plays the voice transmission through the PC's speaker.

The voicemail to e-mail daemon 106 stores new voicemail messages in a spool directory for immediate SMTP delivery to a pre-defined e-mail address corresponding to the called extension. New mailboxes are created by adding an entry for each extension to the registration daemon 102. Once created, voicemail boxes can be utilized by the voicemail to e-mail daemon 106 for leaving messages in a compressed format for play back by a web phone application. Voicemail is called from within the registration daemon's 102 dial plan, the dialing arrangements established for users of the router. Typically, a user would arrange for the voicemail box to be used and a message to be played to a caller whenever the user was busy or unavailable.

The peering daemon 108 supports authentication of incoming and outgoing calls, with fine-grained control to limit access to specific portions of the dial plan. By using dial plan polling, the dial plan for a collection or cluster of network systems can be de-centralized, with each network system only needing to know it's local extensions, and being able to query a central network system for further assistance as required.

The provisioning daemon 110 enables each connected wireless device with a mechanism for updating its system profile with an appropriate extension number and password. Once an extension is provisioned for a particular device, the extensions table in the registration daemon 102 is updated and the web phone application 104 is instantly activated. If a subsequent user tries to activate an already provisioned extension, that user would be notified that the extension already exists in the registration daemon.

Other applications that can be operated within the NetPBX include: voicemail, automated attendant, branch office and telecommuting, automatic call distribution (ACD) and certain administrative controls. A voicemail feature includes the ability for users to receive a voicemail message as an audio attachment to an e-mail account of their choice. This gives the user an easy to manage unified messaging system. Alternatively, users may opt to have a special e-mail notification, without the actual audio attachment, sent to them whenever a new voicemail is received. This gives users an instant alert via e-mail, cell phone or pager once a voicemail message has been received. The e-mail notification can include caller identification information, or simply be a message notifying the user that there is voicemail.

An automated attendant function is implemented through utilization of an interactive voice response (IVR) system. This feature is available for use by both the main reception lines and departmental groups and enables users to customize the greeting prompts that are provided by the IVR.

The ACD feature provides for automatic call routing to the next available agent in a group or department. It includes call queue management when all agents are busy and a caller opt-out of queue option.

The system fully integrates users that are in a branch office or that are telecommuters via the Internet. Remote locations become simple telephone extensions, so users may dial inside extensions or outside numbers just as they would from a central corporate location.

The system is designed to be completely managed and administered by the customer. Through the system's web based management interface, the user may control his user location/work status, voicemail and greeting settings. The manager may control users, groups, lines, stations, and peers.

An additional aspect of the present invention relates to the ability of the softswitch-enabled wireless router to enable voice communication between multiple users connected to the same router, either directly or indirectly, without connection to the PSTN or the Internet. Even though the wireless router is not connected to the PSTN or the Internet, as long as multiple users are registered with the router and assigned extensions, those users could carry out voice communications with one another, and use all of the other aforementioned telephony applications. Because many Wireless-G routers also include full-duplex 10/100 LAN switch functionality, it is possible for multiple personal computers to be simultaneously connected to a single router through Ethernet connections, and for more hubs and switches to be daisy-chained to the router to create a large wireless network. In this manner, all of the users in a building or a campus could be interconnected for purposes of voice communication without any use being made of the Internet or the PSTN.

Although the preferred embodiment of the invention is described in the context of Wireless-G routers, including those made by particular manufactures, the invention is not limited to being implemented solely within such devices. Additionally, while the preferred embodiment of the present invention relies on existing Wi-Fi technologies and standards, the operation of the present invention is not dependent on these technologies or standards and could be adapted to work in connection with other types of technologies and standards.

1. A wireless network telecommunications system for enabling the origination and termination of telephone calls between a user and an outside party at least partially over a packet network through a wireless device connected to said system, comprising:
an access point device for establishing a connection to said wireless device, said access point device including an operating system for controlling the operation of said access point device, and
an application for registering said wireless device with said system when said wireless device is connected to said access point device and assigning said wireless device with an extension that uniquely identifies said wireless device to said outside party, and that enables said user of said wireless device to place a first telephone call to said outside party with said wireless device at least partially over said packet network and that enables said user to receive a second telephone call through said wireless device when said second telephone call is placed by said outside party at least partially over said packet network.

2. The wireless network telecommunications system of claim 1, wherein said access point device is a wireless router.

3. The wireless network telecommunications system of claim 2, wherein said wireless router includes a flash memory and said operating system is implemented within said flash memory.

4. The wireless network telecommunications system of claim 3, wherein said operating system includes a UNIX kernel, a root file system and a read/write file system.

5. The wireless network telecommunications system of claim 4, wherein said router includes one or more telephony applications that operate in conjunction with said operating system.

6. The wireless network telecommunications system of claim 5, wherein said telephone applications includes a web phone application that enables said user to utilize a personal computer to place said first telephone call and to receive said second telephone call.

7. The wireless network telecommunications system of claim 5, wherein said telephone applications includes a voicemail application.

8. The wireless network telecommunications system of claim 5, wherein said telephone applications includes an authentication application that determines whether said user is authorized to utilize said system and regulates information and services available to said user.

9. The wireless network telecommunications system of claim 5, wherein said telephone applications includes an automated attendant application.

10. The wireless network telecommunications system of claim 5, wherein said telephone applications includes an automatic call distribution application.

11. The wireless network telecommunications system of claim 5, wherein said telephone applications includes a remote user application that enables a remotely located user to have access to said system as said user.

12. The wireless network telecommunications system of claim 5, wherein said telephone applications includes a control application that enables said user to establish a series of user preferences and allows an administrator to control said user.

13. The wireless network telecommunications system of claim 2, wherein said wireless router is Wi-Fi enabled.

14. The wireless network telecommunications system of claim 2, wherein said wireless router is Wireless-G router.

15. A wireless network telecommunications system for enabling the origination and termination of telephone calls between multiple users through wireless devices connected to said system, comprising:
an access point device for establishing connections to said wireless devices, said access point device including an operating system for controlling the operation of said access point device, and
an application for registering said wireless devices with said system when said wireless devices are connected to said access point device and assigning each of said wireless devices with an extension that uniquely identifies each of said wireless devices to said multiple users, and that enables a first user of a first wireless device to place a first telephone call to a second user of a second wireless device and that enables said first user to receive a second telephone call through said first wireless device when said second telephone call is placed by said second user with said second wireless device.

16. The wireless network telecommunications system of claim 15, wherein said access point device is a wireless router, wherein said operating system includes a UNIX kernel, a root file system and a read/write file system, and wherein said wireless router includes a flash memory within which said operating system is implemented.

17. The wireless network telecommunications system of claim 16, wherein said router includes one or more telephony applications that operate in conjunction with said operating system.

18. The wireless network telecommunications system of claim 16, wherein said telephone applications includes a web phone application that enables said user to utilize a personal computer to place said first telephone call and to receive said second telephone call.

19. The wireless network telecommunications system of claim 16, wherein said telephone applications includes a voicemail application.

20. The wireless network telecommunications system of claim 16, wherein said telephone applications includes an authentication application that determines whether said user is authorized to utilize said system and regulates information and services available to said user.

21. The wireless network telecommunications system of claim 16, wherein said telephone applications includes an automated attendant application.

22. The wireless network telecommunications system of claim 16, wherein said telephone applications includes an automatic call distribution application.

23. The wireless network telecommunications system of claim 16, wherein said telephone applications includes a remote user application that enables a remotely located user to have access to said system as said user.

24. The wireless network telecommunications system of claim 16, wherein said telephone applications includes a control application that enables said user to establish a series of user preferences and allows an administrator to control said user.

25. The wireless network telecommunications system of claim 16, wherein said wireless router is Wi-Fi enabled.

26. The wireless network telecommunications system of claim 16, wherein said wireless router is Wireless-G router.
